(19) United States
(12) Patent Application Publication
(10) Pub. No.: US 2014/0225019 A1
(43) Pub. Date: Aug. 14, 2014

(54) Automatically Restorable Handle Apparatus

(71) Applicant: ZIPSON STEEL INDUSTRIAL CO., LTD., Chiayi County (TW)

(72) Inventor: Chih-Chien Yin, Chiayi County (TW)

(73) Assignee: ZIPSON STEEL INDUSTRIAL CO., LTD., Chiayi County (TW)

(21) Appl. No.: 13/765,758

(22) Filed: Feb. 13, 2013

(51) Int. Cl. F16K 31/60

(52) U.S. Cl. CPC F16K 31/602
USPC 251/234

(57) ABSTRACT

An automatically restorable handle apparatus includes a mounting seat formed with at least one slide slot, a handle unit and a lever that connects the mounting seat and the handle unit. The handle unit includes at least one handle member and a movable spindle that is movably inserted into the slide slot. The handle member has a sleeve tube, and a guide rod inserted telescopically into the sleeve tube. The guide rod has an outer end section that is connected to and rotatable about the movable spindle. The movable spindle is slidable within the slide slot and between a first position, where the guide rod retracts into the sleeve tube, and a second position, where the guide rod extends out of the sleeve tube.

### BACKGROUND OF THE INVENTION

1. Field of the Invention

The invention relates to a handle apparatus, more particularly to an automatically restorable handle apparatus adapted for installation on a valve.

2. Description of the Related Art

Referring to FIGS. 1 to 3, Taiwanese Utility Model No. M326102 discloses an automatically restorable handle apparatus 1 that is adapted to be mounted on a valve 10. The valve 10 has a valve body 101 and a drive shaft 102 that extends outwardly from the valve body 101. The automatically restorable handle apparatus 1 includes a mounting seat 11, a lever 12, and a handle unit 13 that is connected to the lever 12 and the mounting seat 11 and that is capable of driving a restorable movement of the lever 12.

The mounting seat 11 has two spaced-apart plate bodies 111 that are connected to each other. Each of the plate bodies 111 has a circular pivot hole 112. The lever 12 has a connection portion 121 that is adapted to be connected to the drive shaft 102 for concomitant rotation therewith, a handle mounting portion 122 that is distal to the connection portion 121, and an intermediate portion 123 that interconnects the connection portion 121 and the handle mounting portion 122. The handle mounting portion 122 has a tubular wall 124, and a retaining wall 126 that extends inwardly and transversely from an end of the tubular wall 124 and that has a through hole 125. The handle unit 13 includes a sleeve tube 131 that is connected to the handle mounting portion 122 of the lever 12. The sleeve tube 131 has a mounting channel 132. The handle unit 13 further includes a guide rod 133, a positioning member 134 that is received in the mounting channel 132 and that is installed on the guide rod 133, a resilient member 135 that is sleeved around the guide rod 133 and that abuts against the retaining wall 126 and the positioning member 134, and a rotatable spindle 136 that is rotatably inserted into the pivot hole 112 of each of the plate bodies 111 and that is co-movably connected to the guide rod 133.

As shown in FIG. 2, when the handle unit 13 of the automatically restorable handle apparatus 1 is at a first position, the resilient member 135 is uncompressed and the guide rod 133 retracts into the sleeve tube 131. When an applied force acts on the handle unit 13 in a direction of an arrow 14, the lever 12 is driven by the handle unit 13 to be rotated about a rotation axis of the drive shaft 102 of the valve 10, such that the handle unit 13 of the automatically restorable handle apparatus 1 is moved to a second position as shown in FIG. 3, where the guide rod 133 extends outwardly from the sleeve tube 131. Due to the abutment between the handle mounting portion 122 of the lever 12 and the positioning member 134, the resilient member 135 is compressed to produce a restoring force. When the applied force acting on the handle unit 13 is released, the restoring force of the resilient member 135 is capable of restoring the handle unit 13 to move from the second position to the first position and the drive shaft 102 of the valve 10 is concomitantly rotatable therewith.

Although the abovementioned conventional handle apparatus 1 is automatically restorable between the first and second positions, the lever 12 and the handle unit 13 are rotatable relative to the drive shaft 102 and the movable spindle 136 which serve as pivot axes, respectively, and deflection tends to occur between the lever 12 and the guide rod 133. The deflection may be offset through deformation of the guide rod 133 to an acceptable extent if the valve 10 has a relatively small size. However, when the automatically restorable handle apparatus 1 is intended to be disposed on the valve 10 that has a relatively large size, the deformation of the guide rod 133 required to offset the deflection between the lever 12 and the guide rod 133 reaches an unacceptable extent. In view of this, there is still room for improvement in the automatically restorable handle apparatus 1 for being adapted to be disposed on a valve with a relatively large size.

### SUMMARY OF THE INVENTION

Therefore, an object of the present invention is to provide an automatically restorable handle apparatus that can overcome the aforesaid drawback of the prior art.

According to the present invention, an automatically restorable handle apparatus is adapted for installation on a drive shaft of a valve. The automatically restorable handle apparatus includes a mounting seat, a lever, and a handle unit.

The mounting seat is adapted to be mounted on the valve and includes a pivot portion that is formed with at least one slide slot.

The lever includes a connection portion that is adapted to be connected to the drive shaft for concomitant rotation therewith, a handle mounting portion, and an intermediate portion that interconnects the connection portion and the handle mounting portion.

Being connected to the handle mounting portion and the pivot portion, the handle unit includes at least one handle member and a movable spindle that is movably inserted into the slide slot. The handle member has a sleeve tube that is connected to the handle mounting portion, a guide rod that is inserted telescopically into the sleeve tube and the handle mounting portion, and a resilient member that provides a restoring force to retract the guide rod into the sleeve tube. The guide rod has an outer end section that is extendable out of the sleeve tube through the handle mounting portion and that is connected to and is rotatable about the movable spindle. The movable spindle is slidable transversely within the slide slot and between a first position, where the guide rod retracts into the sleeve tube, and a second position, where the guide rod extends out of the sleeve tube.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view to illustrate a conventional automatically restorable handle apparatus disclosed in Taiwanese Utility Model No. M326102;

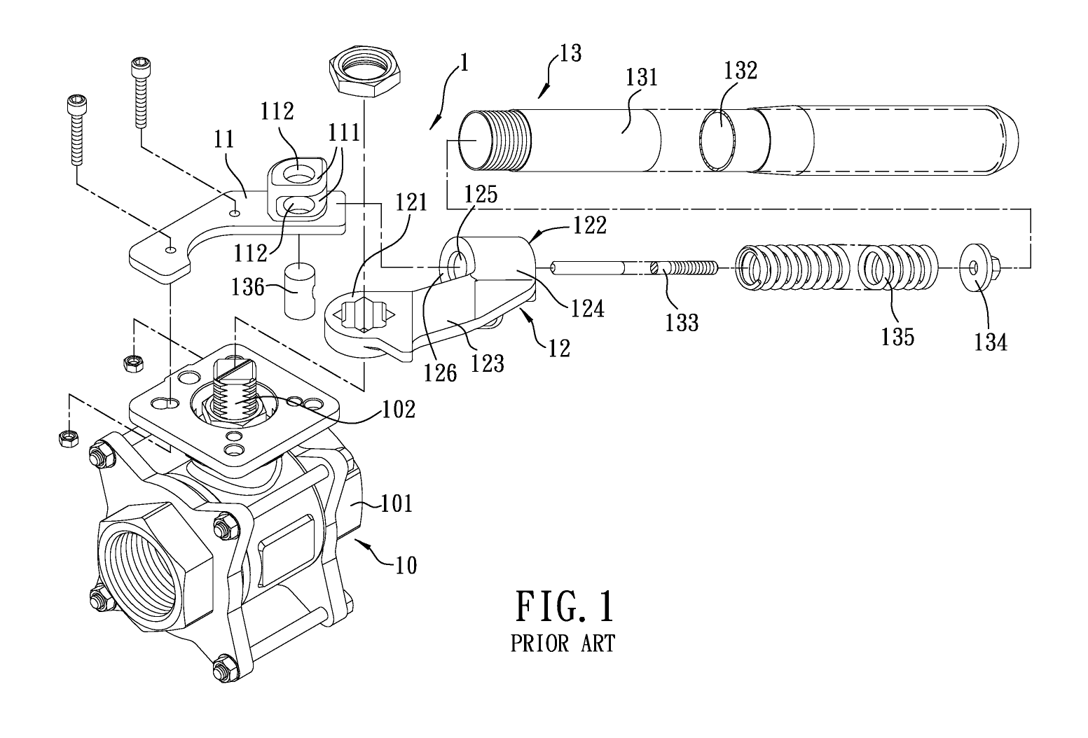

FIG. 2 is a top partly sectional view of the conventional automatically restorable handle apparatus, illustrating a handle unit of the conventional automatically restorable handle apparatus at a first position;

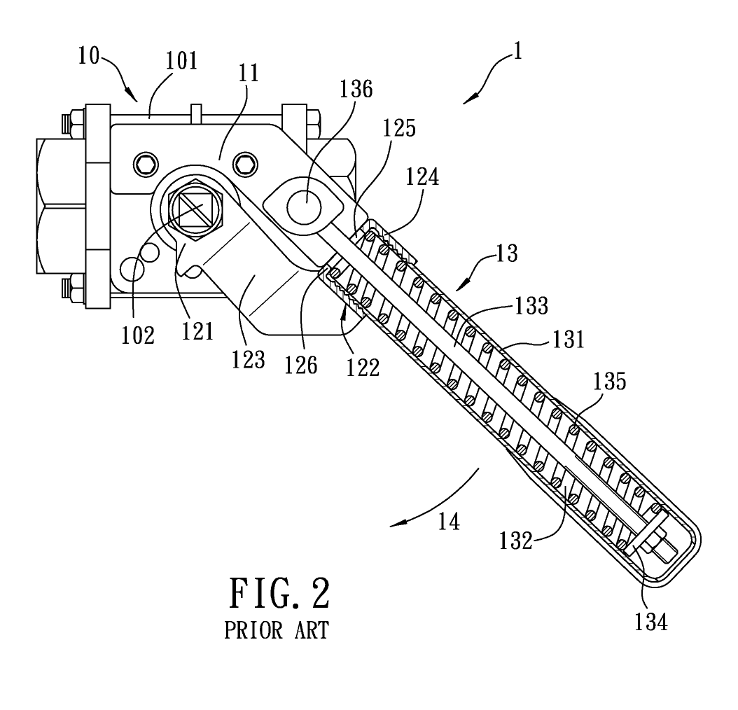

FIG. 3 is another top partly sectional view of the conventional automatically restorable handle apparatus, illustrating the handle unit of the conventional automatically restorable handle apparatus at a second position;

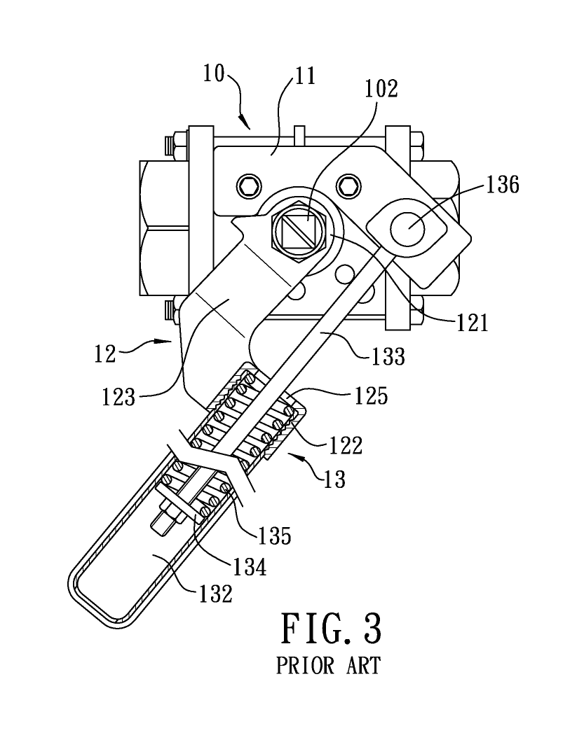

FIG. 4 is an exploded fragmentary perspective view, illustrating the preferred embodiment of an automatically restorable handle apparatus according to the present invention;

FIG. 5 is a top partly sectional view of the preferred embodiment, illustrating a handle unit of the automatically restorable handle apparatus at a first position;

FIG. 6 is a front fragmentary view of the preferred embodiment; and

FIG. 7 is a top partly sectional view of the preferred embodiment, illustrating the handle unit of the automatically restorable handle apparatus at a second position.

### DETAILED DESCRIPTION OF THE PREFERRED EMBODIMENT

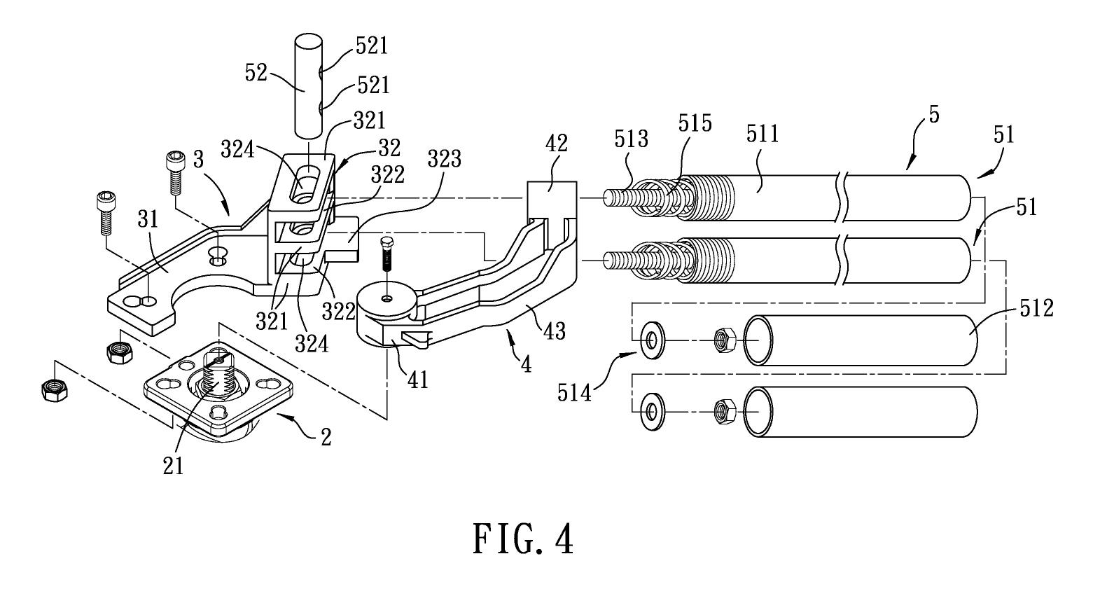

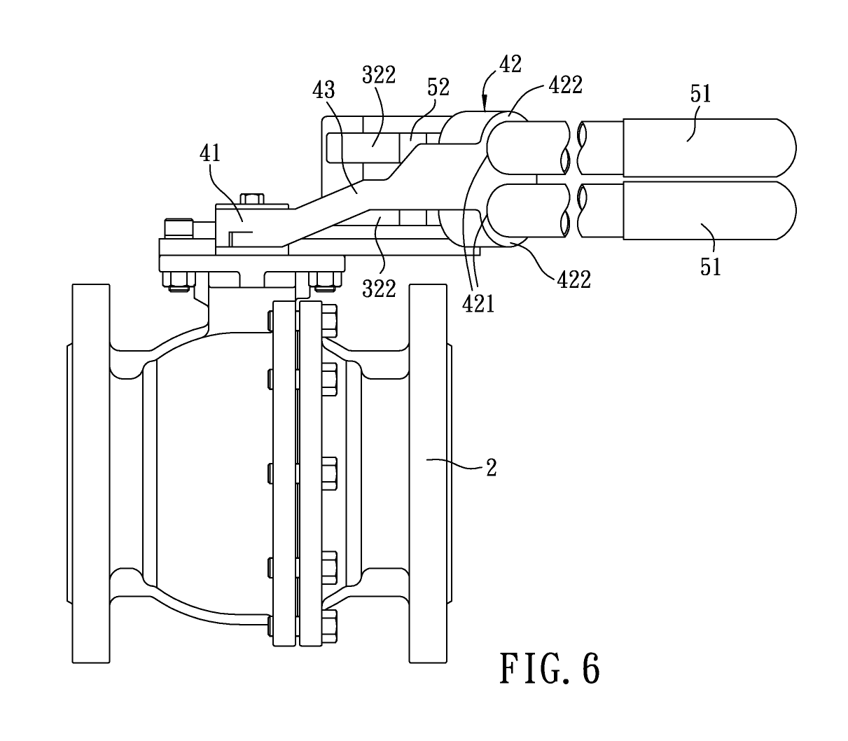

Referring to FIGS. 4 to 6, an automatically restorable handle apparatus of the preferred embodiment according to the present invention is shown to be installed on a drive shaft 21 of a valve 2. The automatically restorable handle apparatus includes a mounting seat 3, a lever 4, and a handle unit 5. The mounting seat 3 is mounted on the valve 2 and includes a pivot portion 32 that is formed with at least one slide slot 324. The lever 4 includes a connection portion 41 that is connected to the drive shaft 21 for concomitant rotation therewith, a handle mounting portion 42, and an intermediate portion 43 that interconnects the connection portion 41 and the handle mounting portion 42. The handle unit 5 is connected to the handle mounting portion 42 and the pivot portion 32. The handle unit 5 includes at least one handle member 51 and a movable spindle 52 that is movably inserted into the slide slot 324. The handle member 51 has a sleeve tube 511 that is connected to the handle mounting portion 42, a guide rod 513 that is inserted telescopically into the sleeve tube 511 and the handle mounting portion 42, and a resilient member 515 that provides a restoring force to retract the guide rod 513 into the sleeve tube 511. The guide rod 513 has an outer end section 518 that is extendable out of the sleeve tube 511 through the handle mounting portion 42 and that is connected to and rotatable about the movable spindle 52. The movable spindle 52 is slidable transversely within the slide slot 324 and between a first position, where the guide rod 513 retracts into the sleeve tube 511, and a second position, where the guide rod 513 extends out of the sleeve tube 511. In this embodiment, the first position refers to a valve-closed state of the valve 2, and the second position refers to a valve-opened state of the valve 2.

The slide slot 324 of the mounting seat 3 has a first end 325, and a second end 326 that is distal from the first end 325. The second end 326 has a distance (h1) that is measured from a rotation axis of the lever 4 and that is smaller than a distance (h2) between the rotation axis of the lever 4 and the first end 325. The movable spindle 52 of the handle unit 5 abuts against the first end 325 when the guide rod 513 is at the first position. The movable spindle 52 abuts against the second end 326 when the guide rod 513 is at the second position.

In this preferred embodiment, the mounting seat 3 has a fixed portion 31 that is fastened on the valve 2 through two fasteners, such as screws, and that is connected to the pivot portion 32. The pivot portion 32 has three plate sections 321 that are spaced apart from and parallel with each other, two receiving spaces 322 each of which is defined by two adjacent ones of the plate sections 321, and an abutment wall 323 that extends outwardly from a lower one of the three plate sections 321. Each of the plate sections 321 has the slide slot 324.

The handle mounting portion 42 of the lever 4 has two tubular walls 422 that respectively have threaded holes 421, and a retaining wall 423 that is connected to the tubular walls 422. The retaining wall 423 has two through holes 424 that respectively communicate with the threaded holes 421. When the movable spindle 52 of the handle unit 5 abuts against the first end 325, the retaining wall 423 abuts against the abutment wall 323 of the pivot portion 32.

In this preferred embodiment, the handle unit 5 includes two of the handle members 51. Each of the sleeve tubes 511 of the handle members 51 is threadedly connected to a corresponding one of the threaded holes 421 of the tubular walls 422. Each handle member 51 has a tube sheath 512 that is sleeved around the sleeve tube 511. Each of the sleeve tubes 511 of the handle members 51 has a mounting channel 516 that communicates with a corresponding one of the through holes 424, such that the outer end section 518 is extendable out of the mounting channel 516 through the corresponding one of the through holes 424. The guide rod 513 of each of the handle members 51 further has a spring-mounted section 517 that extends from the outer end section 518 into the mounting channel 516 and that is sleeved by the resilient member 515. Preferably, each of the handle members 51 further has a positioning member 514 that is installed on the spring-mounted section 517 of the guide rod 513. The resilient member 515 of the handle member 51 abuts against the retaining wall 423 of the handle mounting portion 42 and the positioning member 514. In this preferred embodiment, the positioning member 514 includes a washer and a nut. The movable spindle 52 has two connection holes 521 that correspond in position to the receiving spaces 322 of the pivot portion 32. The outer end section 518 of the guide rod 513 of each of the handle members 51 extends into a corresponding one of the receiving spaces 322 for connecting with the movable spindle 52 through a corresponding one of the connection holes 521. According to this preferred embodiment, the outer end sections 518 of the guide rods 513 are respectively threadedly connected to the connection holes 521 of the movable spindle 52. However, the outer end sections 518 of the guide rods 513 may be connected to the movable spindle 52 in other manners, such as a welded connection.

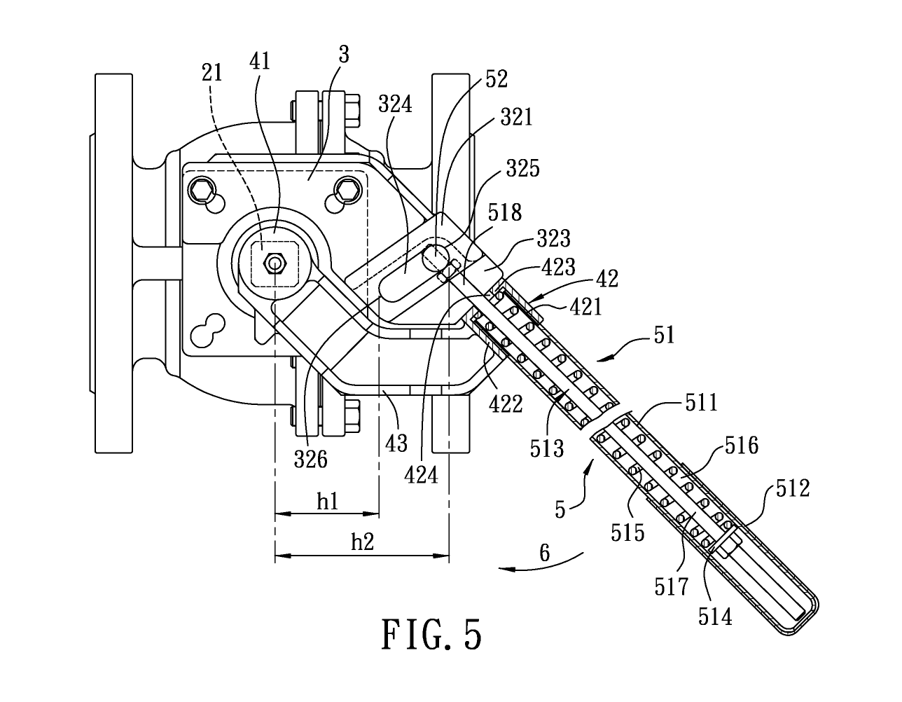

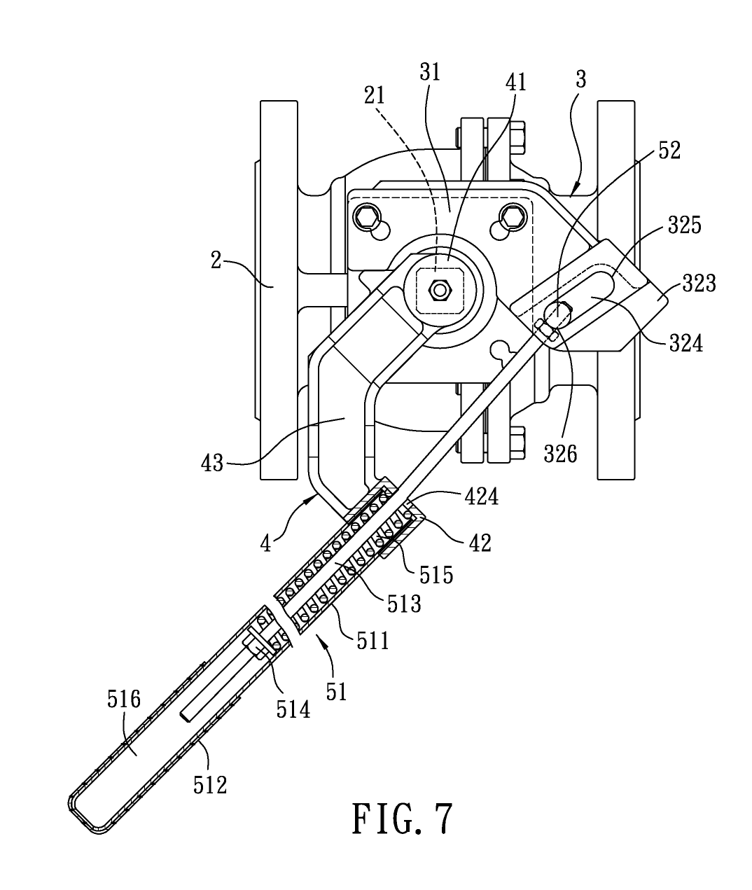

Referring to FIGS. 4, 5, and 7, the movable spindle 52 of the handle unit 5 abuts against the first end 325 of the slide slot 324 of each of the plate sections 321 when the guide rod 513 of each of the handle members 51 is at the first position (as shown in FIG. 5). When an applied force acts on the handle unit 5 in a direction of arrow 6, because the rotation axis of the lever 4 is at the drive shaft 21, the handle mounting portion 42 of the lever 4 is distal from the pivot portion 32 of the mounting seat 3. The resilient member 515 is compressed to produce the restoring force. Meanwhile, because of the movement of the handle mounting portion 42, each of the guide rods 513 extends outwardly from the corresponding one of the sleeve tubes 511. The movable spindle 52 gradually moves from the first end 325 to the second end 326 of the slide slot 324 of each of the plate sections 321. Eventually, the movable spindle 52 abuts against the second end 326 of the slide slot 324 of each of the plate sections 321 when the guide rod 513 of each of the handle members 51 is at the second position (as shown in FIG. 7). When the applied force is released from the handle unit 5, the restoring force of the resilient members 515 may retract the guide rod 513 of each handle member 51 into the corresponding sleeve tube 511 from the second position to the first position, thereby restoring an abutment of the movable spindle 52 and the first end 325 of the slide slot 324 of each of the plate sections 321.

According to the structural design of this invention, a length of the intermediate portion 43 may be varied based on the size of the valve 2 such that the handle unit 5 may be relatively convenient and labor saving in use. By virtue of the movement of the movable spindle 52 of the handle unit 5 within the slide slot 324 of the mounting seat 3, the amount of deflection of the guide rod 513 may be increased. Besides, the number of handle members 51 of the handle unit 5 may be varied for increasing the restoring force, such that the automatically restorable handle apparatus of the present invention is suitable for installation on the valve 2 that has a relatively large size.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An automatically restorable handle apparatus that is adapted for installation on a drive shaft of a valve, comprising:
a mounting seat adapted to be mounted on the valve and including a pivot portion that is formed with at least one slide slot;
a lever including a connection portion that is adapted to be connected to the drive shaft for concomitant rotation therewith, a handle mounting portion, and an intermediate portion that interconnects said connection portion and said handle mounting portion; and
a handle unit connected to said handle mounting portion and said pivot portion, said handle unit including at least one handle member and a movable spindle that is movably inserted into said slide slot, said handle member having a sleeve tube that is connected to said handle mounting portion, a guide rod that is inserted telescopically into said sleeve tube and said handle mounting portion, and a resilient member that provides a restoring force to retract said guide rod into said sleeve tube, said guide rod having an outer end section that is extendable out of said sleeve tube through said handle mounting portion and that is connected to and is rotatable about said movable spindle, said movable spindle being slidable transversely within said slide slot and between a first position, where said guide rod retracts into said sleeve tube, and a second position, where said guide rod extends out of said sleeve tube.

2. The automatically restorable handle apparatus as claimed in claim 1, wherein said slide slot of said mounting seat has a first end, and a second end that is distal from said first end, said second end having a distance that is measured from a rotation axis of said lever and that is smaller than a distance between the rotation axis of said lever and said first end, said movable spindle of said handle unit abutting against said first end when said guide rod is at the first position, said movable spindle abutting against said second end when said guide rod is at the second position.

3. The automatically restorable handle apparatus as claimed in claim 1, wherein said pivot portion of said mounting seat has three plate sections that are spaced apart from and parallel with each other, and two receiving spaces each of which is defined by two adjacent ones of said plate sections, each of said plate sections having said slide slot, said handle unit including two of said handle members, said outer end section of said guide rod of each of said handle members extending into a corresponding one of said receiving spaces for connecting with said movable spindle.

4. The automatically restorable handle apparatus as claimed in claim 3, wherein said slide slot of each of said plate sections has a first end, and a second end that is distal from said first end, said second end having a distance that is measured from a rotation axis of said lever and that is smaller than a distance between the rotation axis of said lever and said first end, said movable spindle of said handle unit abutting against said first end when said guide rod is at the first position, said movable spindle abutting against said second end when said guide rod is at the second position.

5. The automatically restorable handle apparatus as claimed in claim 4, wherein said handle mounting portion of said lever has two tubular walls that respectively have threaded holes, and a retaining wall that is connected to said tubular walls, said retaining wall having two through holes that respectively communicate with said threaded holes, each of said sleeve tubes of said handle members having a mounting channel that communicates with a corresponding one of said through holes, said guide rod of each of said handle members further having a spring-mounted section that extends from said outer end section into said mounting channel and that is sleeved by said resilient member.

6. The automatically restorable handle apparatus as claimed in claim 5, wherein each of said handle members further has a positioning member that is installed on said spring-mounted section of said guide rod, said resilient member of said handle member abutting against said retaining wall of said handle mounting portion and said positioning member.
